(19) United States
(12) Patent Application Publication
(10) Pub. No.: US 2023/0302530 A1
(43) Pub. Date: Sep. 28, 2023

(54) Direct Thixotropic Metal 3D Printing and Apparatus

(71) Applicant: Drexel University, Philadelphia, PA (US)

(72) Inventors: Gongyao Zhou, Wilmington, DE (US); Yifan Fei, Philadelphia, PA (US); Jie Xu, Philadelphia, PA (US)

(73) Assignee: Drexel University, Philadelphia, PA (US)

(21) Appl. No.: 18/118,944

(22) Filed: Mar. 8, 2023

Related U.S. Application Data
(60) Provisional application No. 63/318,100, filed on Mar. 9, 2022.

(51) Int. Cl. B22D 23/00; C22C 1/02; C22C 28/00; B33Y 10/00; B33Y 70/00; B33Y 40/10

(52) U.S. Cl. CPC B22D 23/003; B33Y 10/00; B33Y 40/10; B33Y 70/00; C22C 1/02; C22C 28/00

(57) ABSTRACT

A device and method of thixotropic mixing and 3D printing of alloys is provided. The method includes the steps of locating a thixotropic mixer having a discharge nozzle above a substrate; adding a molten alloy to the mixer; locating the nozzle between about 1 mm and about 20 mm from the substrate; and extruding the alloy from the nozzle onto the substrate.

### STATEMENT OF GOVERNMENT INTEREST

This invention was made with government support under Contract No. CMMI-2027823 awarded by the National Science Foundation. The government has certain rights in the invention.

### CROSS-REFERENCE TO RELATED APPLICATION

The present application claims the benefit of U.S. Provisional Pat. Application Serial No. 63/318,100, filed on Mar. 9, 2022, which is incorporated herein by reference in its entirety.

### BACKGROUND OF THE INVENTION

For traditional metals such as titanium and stainless steel, laser melting/sintering of powders is a typical additive manufacturing (AM) process. However, laser melting/sintering, not mentioning its slow and expensive process, is technically not suitable for chemically reactive metal powders such as Al, Mg and Zn powders because these powders under normal conditions are covered naturally by a passivated oxidation layer. Al, Zn, and Mg oxides have melting temperatures close to 2000° C. or even higher. The high laser energy needed to break the oxides leads to poor fusion quality caused by undesired metallurgical defects such as porosity, cracking, and evaporation of alloying elements. Likewise, other powder-based binding (e.g., using an organic binder) and sintering processes are also not suitable for processing Al, Mg, and Zn alloys into precision parts with high fusion quality.

Ideally, liquid-state deposition by jetting or by extrusion is highly desired in additive manufacturing of mid-melting-point (around 500° C.) Al, Mg, and Zn alloys. Currently, almost all commercially available jetting/extrusion machines rely on a binder material to formulate a printable compound for metallic materials. One major drawback of exists method is additional post-printing process such as debinding and sintering. In jetting, droplets of building material are formed by capillary breakup and selectively deposited on substrate; by comparison, in extrusion, material is extruded as a liquid thread and deposited on substrate (according to ISO/ASTM 52900 Standard). In recent years, the material extrusion technique has already been evolved into a mature technique for several other materials such as polymer, composites, hydrogel, etc. However, liquid-state deposition of molten metal with accuracy suitable for additive manufacturing remains to be an immense challenge. The difficulty arises from the unfavorable rheology of molten metals, that is, extremely low viscosity but exceptionally high surface tension. This leads to uncontrollable coalescence and breakup of the fluid under normal conditions, as such neither controllable droplets nor stable liquid threads can be formed.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1A. Microstructure of solidified alloy: dendritic microstructure in an as-cast sample;

FIG. 1B. Microstructure of solidified alloy: a globular microstructure in a semisolid alloy sample;

FIG. 2. Process design for thixotropic shearing-mixing and 3D printing of alloy with a dispersed grain structure;

FIG. 3. Illustration of the components in the thixotropic metal extruder;

FIG. 4. Plunger extrusion based printing system design;

FIG. 5A. Funnel-shaped printing nozzle;

FIG. 5B. Axisymmetric model for flow and extrusion;

FIG. 6. Flow front displacement for varied Oh number;

FIG. 7A. Thixotropic fluid interface at Oh=0.0167;

FIG. 7B. Thixotropic fluid interface at Oh=167;

FIG. 7C. Thixotropic fluid interface at Oh=833;

FIG. 8A. Simulation model of the reservoir;

FIG. 8B. Cross-sectional area of simulated domain with boundary condition and a heat source located at the outer boundary of the reservoir;

FIG. 8C. Liquid fraction distribution within the reservoir for setup temperature of 70.8° C.

FIG. 9A. Thixotropic processing and 3D printing of two testing alloys: phase diagram of In-Ga alloy;

FIG. 9B. A syringe-based 3D printer;

FIG. 9C. printed molten gallium metal;

FIG. 9D. manually printed lines from thixotropic 70In-30Ga alloy on glass substrate;

FIG. 9E. manually printed lines from thixotropic 56Bi-44Pb alloy;

FIG. 10. Comparison of printed lines with different sizes of nozzle;

FIG. 11. Illustration of line width under different extrusion speed, both unstable and stable lines are presented in different zones with wo different nozzle diameters being compared: 1.5 mm and 1.0 mm;

FIG. 12. Line width distribution at variable nozzle-to-substrate distance from 1 mm to 30 mm;

FIG. 13A. Extrusion results with substrate moving acceleration lower than 50 mm/s²;

FIG. 13B. Extrusion results with substrate moving acceleration higher than 50 mm/s²;

FIG. 14. Comparison of line width under different platform moving speed;

FIG. 15A. Printed line for 1.5 mm diameter nozzle;

FIG. 15B. Printed line for 1.0 mm diameter nozzle;

FIG. 15C.Thixotropic bismuth alloy was extruded out from the reservoir at an extrusion speed of 7.87 mm/s;

FIG. 15D. Printing test for 1.5 mm nozzle with zig-zag geometry, the first section of the line being considered as the extruder preparation section, and the material became stable and continuous after this section; and

FIG. 16. A schematic diagram of an alternative embodiment of a system for 3D printing a thixotropically formed alloy.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

### Thixotropic Property and Semi-Solid Metal Processing

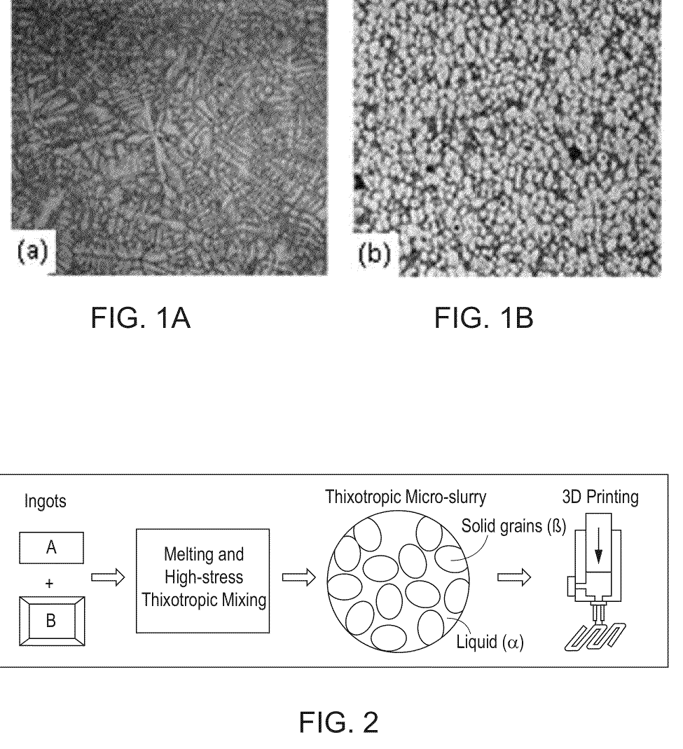

Thixotropy refers to a material’s yielding and shear-thinning properties. When the material is sheared, the material thins, but when the material is allowed to stand, the material thickens again. For a suspension or slurry, this behavior is related to the disintegration of solid particle agglomerates in the presence of shear and their reformation after the shear is removed. For a metallic alloy under cooling, this behavior is observed when the microstructure is composed of solid spheroids suspended in a liquid matrix, as shown in FIGS. 1A and 1B. Thixotropy forms the theoretical foundation for semi-solid metal (SSM) processing, and as a results several SSM processing methods have already been developed and commercialized for molding and casting applications. In particular, continuous stirring and extrusion is one popular SSM method for the alloy industry, and thixomolded magnesium alloy has become one of the major products for light-weight structural applications including components for automotive applications.

Liquid-state deposition by jetting or by extrusion represents the most cost-effective and successful techniques in additive manufacturing. In jetting, liquid droplets are created while in extrusion, a liquid filament is generated. Jetting-based and extrusion-based machines share many common features in design, and both are simple compared with beam-based melting/sintering machines. 3D printing machines are now widely available from leading manufacturers including 3D System, Stratasys, XJET, HP, Voxeljet, ExOne, Desktop, and Prodways. They can be divided into two groups: direct deposition and binder deposition. Nevertheless, for metallic materials, all commercially available jetting/extrusion machines rely on a binder material (mostly organic materials) for formulating a printable compound; direct printing of molten metal for controllable freeform 3D fabrication has not yet been achieved.

This difficulty in liquid-state deposition of molten metal is understandable by examining the Ohnesorge number, Oh, defined as a ratio of viscous force over the combined inertia and surface tension forces,

$$\text{Oh} = μ / \sqrt{ρ σ L} \qquad \text{Equation (1)}$$

where µ is viscosity, p is density, σ is surface tension, and L is characteristic size. For molten metal, the surface tension is typically about several 100s of mN/m, while the viscosity is very low, about a few centipoises (mPa·s). For a 0.1 mm sized droplet, the Oh number is calculated to be on the order of 0.005 (assuming p ≈ 5000 Kg/m³). For jetting of droplets, the needed Oh number is typically in the range of 0.1 to 1. On the other hand, for stable formation of a liquid filament, a larger Oh number much greater than 1 is needed. It then becomes apparent that neither droplets nor filaments as desired in 3D printing can be formed in a stable, controllable manner for molten metal. Actually, molten metal is extremely hard to harness under normal extrusion conditions; the ultrahigh surface tension dictates instability such as coalescence and breakup, especially sensitive to process variations and local geometrical changes. The large surface tension also makes adhesion to the substrate difficult. As such, currently there exists an immense difficulty in liquid-state deposition/printing of molten metal.

From perspectives of fluid physics, the surface tension in general is not easy to modify, but the viscosity is. Therefore, one may increase the viscosity (or flow resistance forces) so that the Oh number becomes sufficiently large for filament formation. Actually, some limited work has been conducted to improve filament formation of liquid metal by increasing flow resistance, e.g., through alloy formulation. However, existing ideas have only generated limited initial results and still remain as scientific subjects to be explored.

For low-melting and chemically reactive alloys such as Al, Zn and Mg based alloys, enabling direct extrusion is of a particular significance, since powder-based fusion processes do not work well for these alloys due to the passivation layer. Cost-effective printing of these alloys would lead to a revolutionary improvement on the products of medical devices, engineering and industrial product and beyond. Therefore, a new technical approach for breaking the physical limit set by an extremely low Ohnesorge number of molten alloy and enabling direct printing is highly desired.

### Manufacturing Process and System Development

The main objective of this research is to explore a novel manufacturing system that is capable of thixotropically processing and 3D printing of low melting point alloys such as Al, Mg, Zn alloys into various devices and products. To enable direct extrusion of molten metal, one has to find a practically viable approach for substantially increasing the Ohnesorge number. From Eq. (1)), this requires increasing of viscosity or decreasing of surface tension. Therefore, one has to modify the material properties of the liquid metal by increasing the flow stress and decreasing the negative effects from the high surface tension. In this paper, some low melting point alloys were made into a thixotropic fluid, like a toothpaste, having a desired non-Newtonian fluid property for direct extrusion. A thixotropic fluid is characterized with a high viscosity and a yield stress at a low strain rate, but the fluid thins at increasing strain rate. Inside the nozzle, the viscosity is low because of high shear rate, so flow is enabled. Outside the nozzle, the shear rate rapidly vanishes, so a yield stress is produced to counterbalance the surface tension. This thixotropy not only permits the printing fluid to form a stabilized paste-like filament during printing and furthermore allows the printed fluid not to sag in the absence of a mold, thus enabling direct 3D printing with high geometrical control.

Thixotropy is not completely new in alloy processing. Actually, near net-shape manufacturing processes by semisolid processing are currently available, including thixocasting, rheocasting and thixomolding. Semisolid processing has several advantages: 1. The capital investment and operating costs is significantly lower compared with conventional casting methods. The whole process can be contained within one machine so that the need for melting and holding furnaces as well as melt treatment are all avoided. Foundry cleanliness is easy to maintain, and energy requirements are less because complete melting is not required, cycle times are reduced, and scrap is minimized. 2. Shrinkage and cracking within the mold are reduced because the alloy is already partly solidified in cast. 3. Lower operating and pouring temperatures lead to an increase in the life of metal dies. 4. Composite materials can be readily produced by adding microspheres, fibers or other solid particulates into the feedstock (often referred to as compo casting). Despite these advantages, all existing processes need a mold for shaping. The thixotropy generated in existing processes is considered not adequate and suitable for 3D printing. The solid inclusions in these processes are large in size and irregular in shape, often containing large dendritic structures. A mixer was designed for producing a printable micro-slurry from metallic alloys. The resulting micro-slurry is a two-phase structure, containing a fine β-phase grains (of a high melting point) uniformly dispersed in a molten α-phase. This micro-slurry is then directly fed into a filament extruder for 3D printing, as illustrated in FIG. 2.

### Thixotropic Metal Extruder Design

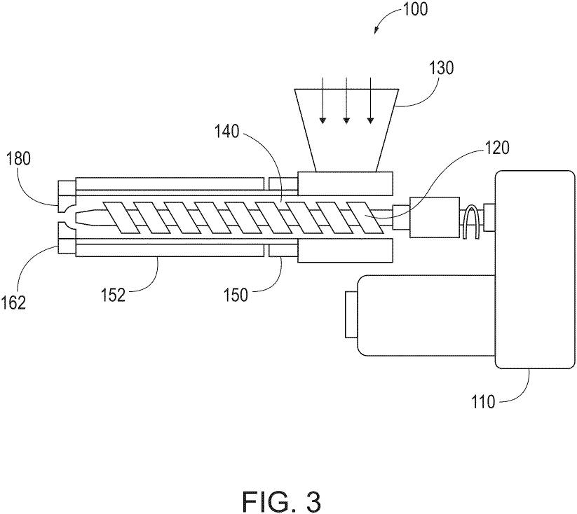

The core part of the thixotropic metal extruder 100 was designed in conjunction with the following components (FIG. 3): a drive train comprised of a motor and gearbox 110, an auger bit 120 operatively connected to the drive train, a hopper 130 for receiving the slurry material and depositing the slurry material to the auger bit 120, a material transfer channel 140 housing the auger bit 120 and configured to receive the material from the hopper 130, a first heating 150 in the material transfer channel 140 and configured to heat the material to a first temperature, a second heating element 152 in the material transfer channel 140 and configured to heat the material to a second temperature, different from the first temperature, and a nozzle 160 located downstream of the auger bit 120 and configured to discharge the alloy from the mixer 100. The body of the extruder 100 was modified by a Filabot EX2 polymer filament extruder. The heating system comprise three sections: a high-temperature region 150 for material melting, a low-temperature region 152 for semi-solid formation, and a nozzle reheat region 162 in nozzle 160. The region 150 of high-temperature heating is located near the material feeding hopper 130. When raw material pellets are inserted into the machine 100 via the hopper 130, the auger bit 120 transports them to the heating region 150. This section’s heating temperature is slightly higher than the material’s melting point.

The purpose of establishing a high temperature in this section is to melt or soften the raw material. Dual element heating tape (from Omega Engineering) is chosen as a heating element in high-temperature heating regions 150. This heating tape has a maximum heating temperature of 1400° F. (760° C.), which is suitable for the majority of low melting metals. Alternatively, the heating element can be replaced with an induction heater so that the metal melts while simultaneously generating globular microstructure. The region of low-temperature heating 152 is equipped with a fiberglass heating rope (from Omega Engineering) capable of producing heat up to 900° F. (482° C.). The material in this section is cooled and sheared as the auger bit 120 rotates. When the temperature decreases, the molten metal begins to transition from the liquid to the solid phase. The shearing action within the channel aids in grain size reduction and the formation of near-globular grains. After passing through the low-temperature section 152, the processed material is reheated and squeezed out through the nozzle 160 to form small beads. The nozzle 160 is connected to a band heater 162 in this section to maintain a constant heating temperature. With reheating, a semi-solid slurry’s solid fraction is reduced, and the material’s viscosity is decreased for easy flow. The disbursement of the alloy from the nozzle 160 are performed in the absence of total solidification of the alloy.

### Thixotropic Printing System Design

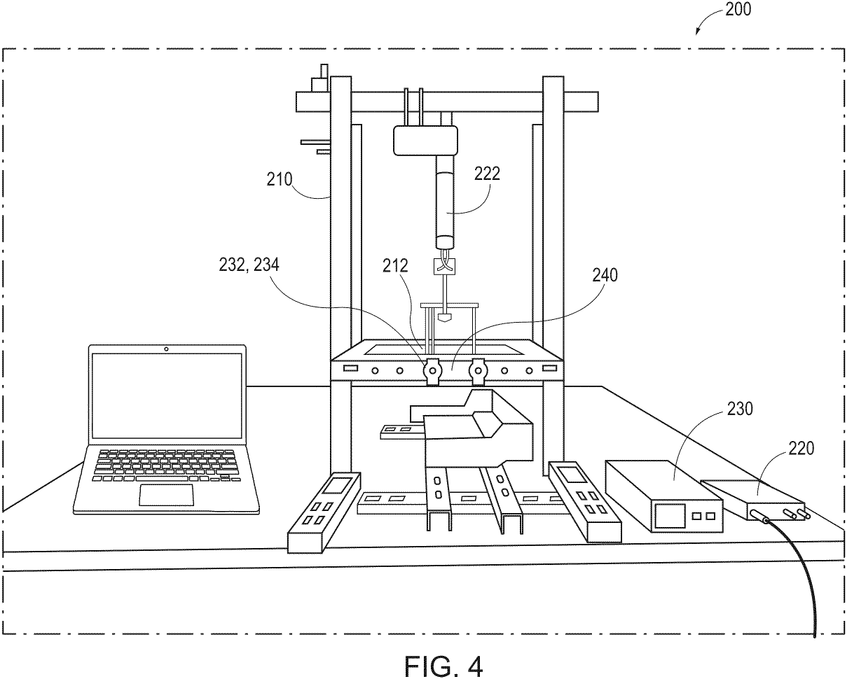

An exemplary thixotropic printing system 200 is composed of an extrusion printing nozzle mounted on a support frame 210 that also houses a reservoir 212 and extrusion mechanism 222 with a linear actuator. FIG. 4 illustrates the frame design 210 and the major controlling system mounted on it. The frame 210 is supported by steel struts and features an adjustable central holding area for the reservoir 212. A motion controller 220 controls the electric linear actuator 222 (IP66 series from Progressive Automations) that moves at a speed of 3.8 mm/s -38.1 mm/s. Three control systems are incorporated into the design. Through the extrusion motion controlling system 220, the actuator and motion controllers are connected. The motion controlling system 220 can adjust the extrusion speed to the extrusion requirements of the material. A temperature PID control system 230 consists of two heating regions 232, 234. Both heating regions 232, 234 are controlled by benchtop PID controller 230 (from Omega Engineering). According to the measurements, the actual temperature received inside the channel is on average 5° C. less than the PID setup temperature. In an exemplary embodiment, the input temperature for heat tape 232 is set to 78° C., while the input temperature for heat tape 234 is set to 69° C. Due to the fact that the printing material is produced as pellets, the melting rate is significantly faster than with a conventional ingot. The auger bit 120 rotates at a speed of 60 rpm, depending on the melting condition of the material. An alloy processed by the extruder 100 is extruded out as a semi-solid slurry using 1 mm-1.5 mm outlet nozzle 160 and transferred to printing system 200 for printing. The material is printed on the substrate 240 as a result of gravity and extrusion force.

### Simulation and Prediction

### Modeling and Simulation of Thixotropic Metal 3D Printing

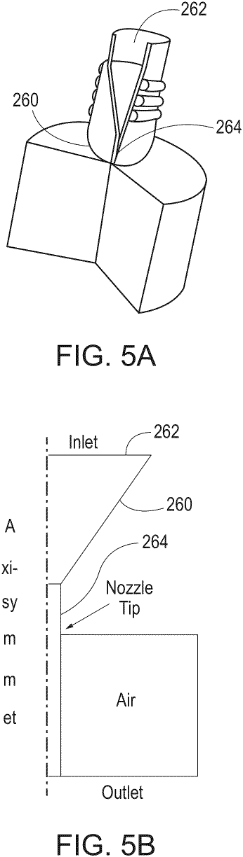

Computer simulations were conducted to study the free surface flow during extrusion and 3D printing. A funnel-like nozzle 260 is used in the geometrical model, as shown in FIG. 5A. The funnel has entry and exit diameters 262, 264, respectively, of 40 mm and 2 mm. The free-surface flow is modeled in an axisymmetric 2D domain, as shown in FIG. 5B. A thixotropic metal slurry enters the funnel 260 from the inlet 262 and then flows out of the nozzle tip 264 to evolve into a free-surface flow surrounded by air. Surface tension is applied at the slurry-to-air interface. The rheological properties (including yield stress and viscosity) of a thixotropic fluid is supposed to depend on the solid fraction and structure. In this preliminary study, only the effect of variable viscosity of the thixotropic fluid was considered, leading to a variable Ohnesorge number (Eq.1)). The density is set to a representative values of 4000 Kg/m³. For the nozzle size of 2 mm, the Oh number used in the simulation ranges from 0.001 to 1000. In moving boundary flow simulation, the free surface is often tracked using the level set method or the phase field method. In this preliminary study, the level set method is used, where the interface is tracked by a level set function ϕ governed by

$$\frac{d ϕ}{d t} + γ \left[∇ ⋅ \left(ϕ \left(1 - ϕ\right) \frac{∇ ϕ}{\left|∇ ϕ\right|}\right) - ε {∇}^{2} ϕ\right] = 0 \qquad \text{Equation (2)}$$

where t is time, and γ and ε are parameters controlling numerical convergence. A similar method has previously been used by others to simulate inkjet printing and channel flow of thixotropic fluids.

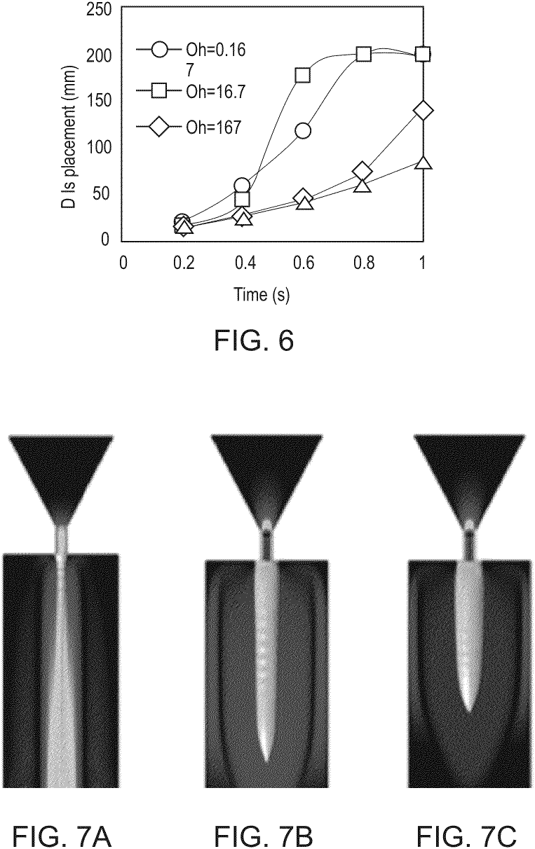

As an example, some simulation results about the effect of the Oh number on the flow front displacement are provided here. The Weber number (defined as We = ρu² L/σ where u is velocity) is set constant at We = 0.018 . As shown in FIG. 6, for a low Oh number (e.g., Oh = 0.167 ), the flow front is leveled off as time increases. This indicates that continuous extrusion is not possible at low Oh number or low viscosity. On the contrary, at higher Oh number (corresponding to high viscosity), the flow front continuously penetrate forward. The simulation also show that the flow front moves slower at a high Oh number, and the diameter of the extruded filament becomes larger (see FIGS. 7A-7C for a snapshot). This can lead to a stable filament extrusion process at high Oh number. In fact, the preliminary experimental work also showed that a thixotropic fluid with a high viscosity is highly controllable during printing and the extruded filaments can be readily deposited on the printing platform. The simulation results presented above demonstrate the importance of viscosity in affecting the extrusion and printing process.

### Simulation for Material Liquid Fraction and Temperature Distribution

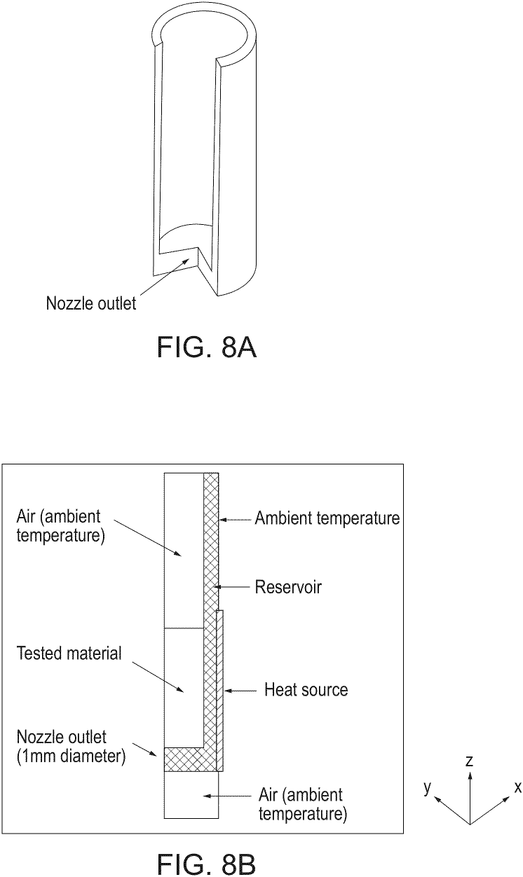

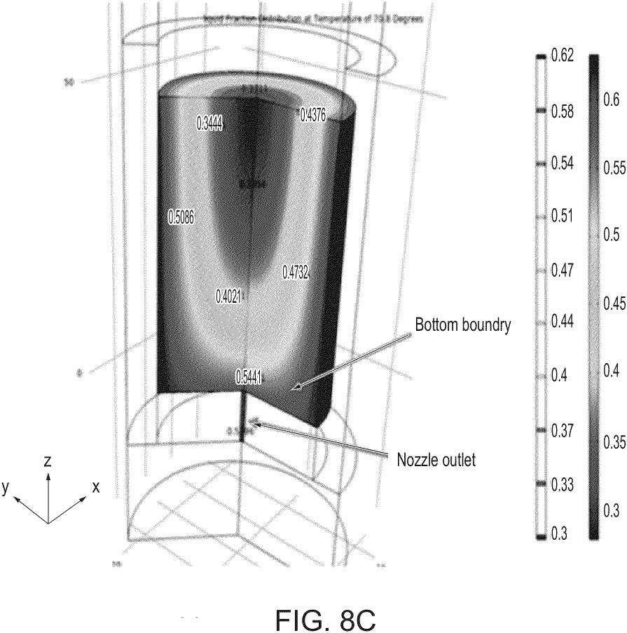

The purpose of simulation within the reservoir is to determine the liquid fraction of material contained within the reservoir when the desired heating source is used. In this simulation, a simplified reservoir with an integrated 1 mm diameter nozzle is adopted, and a Bi-Pb alloy is used as a material. It is assumed that the alloy would remain stable within the reservoir. The heating source is defined to cover a specific boundary region of the reservoir. The geometry configuration is depicted in FIG. 8A. The boundary conditions of the two-dimensional cross-sectional view are shown in FIG. 8B. Both top and bottom of the reservoir are defined as the boundary of air. Both air and the outer boundary are assumed to be at ambient temperature (20° C.).

The major factor in this simulation is liquid fraction. The general liquid fraction can be defined as

$${f}_{l} = {\left(\frac{{T}_{m} - T}{{T}_{m} - {T}_{l}}\right)}^{\frac{1}{{k}_{p} - 1}} \qquad \text{Equation (3)}$$

where Tₘ is melting point of the solid phase, T_{L} is liquidus temperature of the low-melting-temperature phase, and kₚ is equilibrium partition coefficient.

A Bi-Pb alloy is chosen as a material in the simulation. The corresponding material properties for this alloy are σ = 0.4371-0.000066T (N/m), ρ = 11096 -1.3236T (kg/m³), cₚ = 159 - 0.00272T + 7.12(10⁻⁶)T² (J/kg/K), λ = 3.61+0.01517T -1.714(10⁻⁶)T² (W/m/K), T₁ = 343 K, and η = 0.000494exp (754.1/T) (Pa · s), where ρ is density, cₚ is isobaric specific heat, λ is thermal conductivity, and η is dynamic viscosity.

In an ideal estimate, a liquid fraction of around 0.4-0.6 is desired for a semi-solid slurry to become a suitable printing material. When the liquid fraction is less than 0.2, the material is closer to a solid; in contrast, when the liquid fraction is greater than 0.7, the material is closer to a liquid. Temperature and liquid fraction are calculated in this simulation as a function of time over a period of time. The simulation is adjusted to reach a steady state on a time scale of approximately 30 minutes that is comparable to the observed thermal response in the actual experimental observation on the laboratory setup. As illustrated in FIG. 8C, the material around the bottom boundary has a liquid fraction of approximately 0.55 for the 70.8° C. test, while the liquid fraction at the nozzle outlet is 0.579.

The simulation results indicate that the nozzle region of this Bi-Pb alloy requires accurate temperature control. In this case, the temperature range required to generate the desired material liquid fraction is only 0.51° C. The bottom boundary and the nozzle outlet must have a similar temperature distribution to produce a uniform liquid fraction. Simulated temperature setup and liquid fraction distribution can be used to optimize the heating system design for the printing test. However, the physical setup must take into account the actual heat loss during the heating process and the nozzle attachment. Overall, this reservoir simulation with varying heating temperatures provides in a meaningful prediction tool to guide the design of the experimental setup. In fact, with the aid of the simulation, the heating efficiency was improved and the temperature differential between the PID input and actual heating temperatures was reduced.

### Experiments

Initial printing experiments with indium-gallium alloy and bismuth-lead alloy:

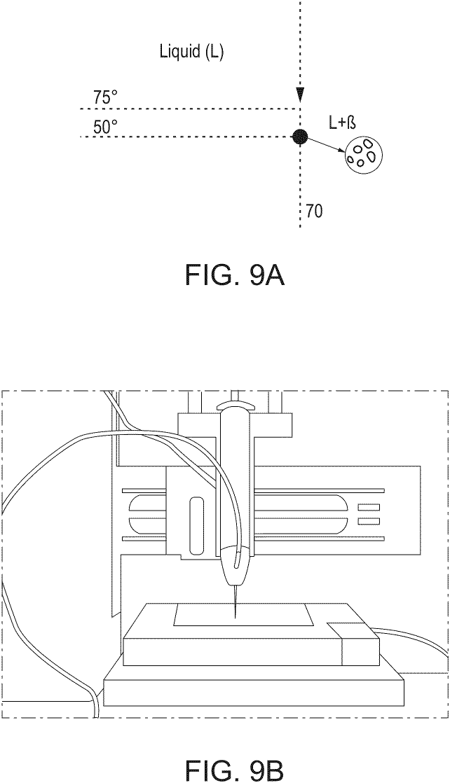

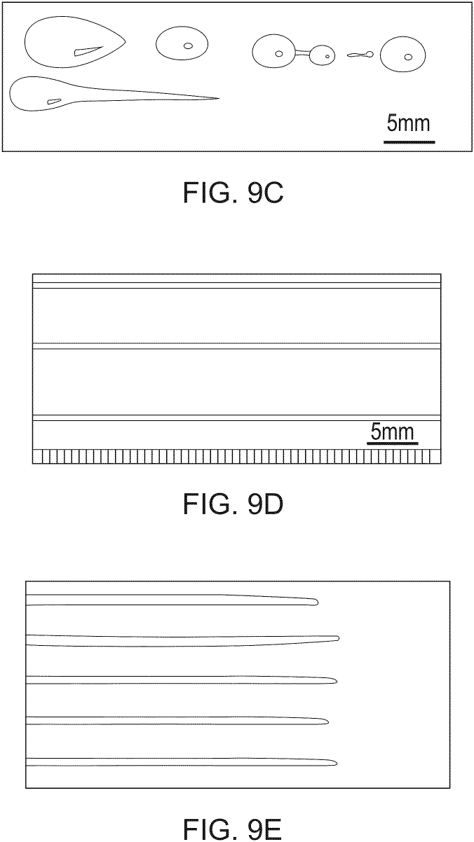

Due to practical limitations from materials, equipment, and facility, only several alloys with very low melting point were chosen for initial tests. A preliminary study was conducted to test the feasibility of thixotropic alloy as an additive manufacturing material. This section describes the results from an indium-gallium alloy. Indium-gallium alloy is well-known for its electrochemical and rheological properties. Therefore, some researchers have focused on developing electronic circuits and microchannels using In-Ga based alloys. Following the In-Ga phase diagram, shown in FIG. 9A, it was decided to choose a 70/30 In-Ga composition for testing. From the phase diagram, it is anticipated that when the molten alloy is cooled to about 75° C., a two-phase structure containing a liquid phase and a solid phase would be formed. Specifically, indium was melted at 170° C., and then gallium was added and mixed well at this temperature. The alloy was then gradually cooled to about 50° C. while under vigorous mixing. The resulting mixture at 50° C. was a paste-like material, able to form sharp shapes when deformed and sustain the deformed shape, indicating formation of a thixotropic fluid. This material was used for 3D printing using a syringe-type printer, as shown in FIG. 9B. The printing results are compared in FIGS. 9C and 9D. For molten gallium, the motorized syringe was not able to control the extrusion of the fluid when depositing on the glass substrate, leaving droplets of uncontrollable sizes, shown in FIG. 9C. In contrast, the In-Ga thixotropic alloy was able to be printed into lines, shown in FIG. 9D. These results indicate that by forming a thixotropic paste, a two-phase alloy may be printed using an extrusion-based 3D printer.

In addition, a 56/44 bismuth-lead alloy was also tested. Typically, the bismuth-lead alloy was used as a solder or an easy-handle material for casting. The alloy was heated to 150° C. to form a liquid alloy, and then the temperature was reduced. The alloy was vigorously mixed during cooling. A paste-like slurry was formed around 75° C. at which the material fluidity was significantly decreased. This thixotropic material was manually printed by movement of a graphite extruder (with 1 mm hole). Line patterns with sharp tips, shown in FIG. 9E were successfully printed.

### Printability Study

### Effects of Nozzle Diameter

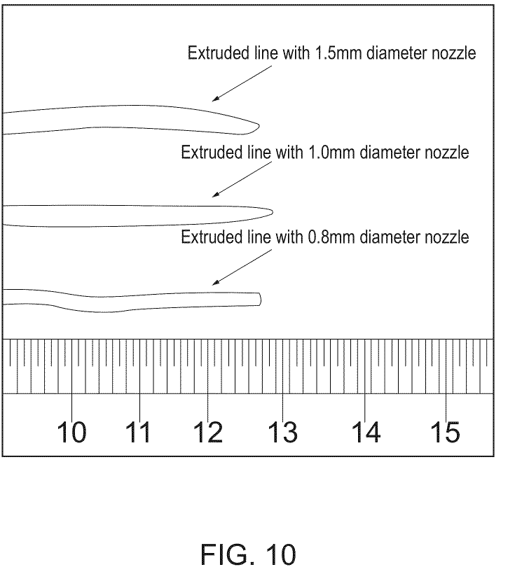

It should be noticed that all the experiments in this printability study were conducted 4 times for statistically average values. With the steady-state thermal control of the extrusion and printing system, a stable material solid fraction inside the reservoir can be developed. The printing quality resulting from this steady-state system was then evaluated using nozzles with 3 different outlet diameters: 1.5 mm, 1.0 mm, and 0.8 mm. All these printing nozzles were machined as a single piece to mount to the bottom of the reservoir. Throughout the extrusion process, the key process parameters including PID set value, extrusion speed, X-Y platform moving speed, and gap distance between nozzle tip and substrate were maintained (Table 1). The printed lines were measured, and their mean values were used to determine the printing resolution (line width) (Table 2). The comparison of printed lines from nozzles with different sizes is shown in FIG. 10.

TABLE 1

Setup of printing parameters for the test to study the effects of nozzle size

| | |
|---|---|
| Printing Parameters | Values |
| PID set value [°C] | 83° C. |
| Extrusion speed [mm/s] | 7.87 mm/s |
| X-Y platform moving speed [mm/s] | 4 mm/s |
| Distance between nozzle tip and substrate [mm] | 15 mm |

TABLE 2

Comparison of average (5 times) line width with different nozzle diameters

| Nozzle Diameter [mm] | Average Line Width [mm] | % Difference |
|---|---|---|
| 1.5 | 1.85 | 23.45% |
| 1.0 | 1.32 | 32.05% |
| 0.8 | 1.01 | 31.21% |

As illustrated in Table 2, a 1.5 mm diameter nozzle can extrude a continuous line with a width of 1.85 mm. Under the same conditions, a 1.0 mm nozzle can print lines as thick as 1.32 mm, while a 0.8 mm nozzle can print lines as thin as 0.8 mm. As observed, lines printed by a 1.5 mm nozzle are 23% larger in diameter than their outlet diameter. Lines extruded from 1 mm and 0.8 mm nozzles, on the other hand, are approximately 31% larger than the outlet diameter. From these results, it can be seen that there is a die swell effect in thixotropic printing, and the amount of die swell seems to be dependent on the shear rate. Note that, the shear rate for the 1.5 mm nozzle is the lowest of the three; this may contribute to the reduced amount of die swell. Nevertheless, the nature of the die swell effect in thixotropic extrusion must be studied into detail to uncover the fundamental mechanism. This is beyond the current scope of work but can be incorporated into future work.

### Effects of Extrusion Speed

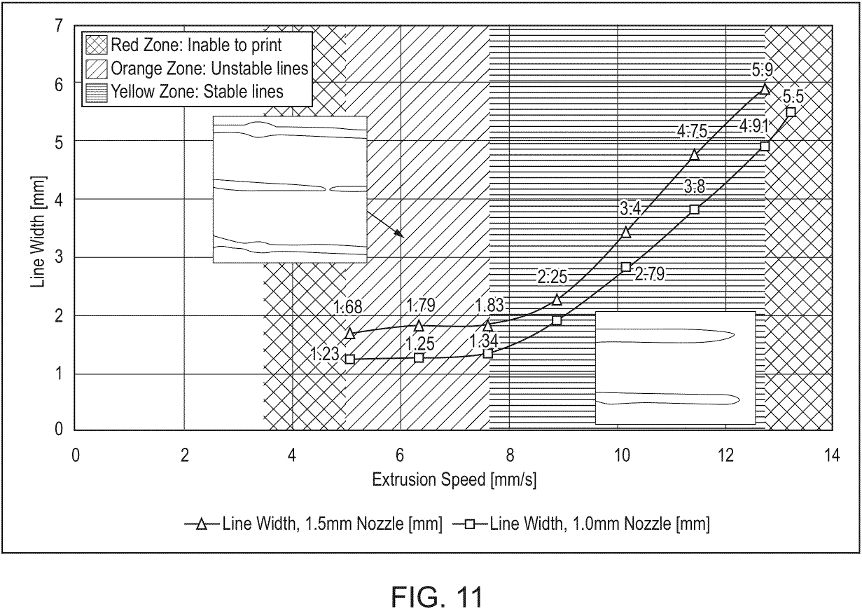

An electric linear actuator (IP66 series from Progressive Automations) was used in the printing system. The actuator control box allows the extrusion speed to be adjusted between 3.8 and 38.1 mm/s. The actual extrusion speed in the testing experiments was varied between 3.81 and 13.21 mm/s. Other printing parameters are maintained at their default values (Table 3). Straight lines were printed using nozzles with outlet diameters of 1 mm and 1.5 mm. The width of each printed line was measured, and the results are plotted and compared, as in FIG. 11.

TABLE 3

Setup of printing parameters for the test to study the effects of extrusion speed

| | |
|---|---|
| Printing Parameters | Values |
| PID set value [°C] | 83° C. |
| Nozzle diameter [mm] | 1.5 mm and 1 mm |
| X-Y platform moving speed [mm/s] | 4 mm/s |
| Distance between nozzle tip and substrate [mm] | 15 mm |

As illustrated in FIG. 11, both the 1.5 mm and 1.0 mm nozzles were started at a 3.81 mm/s minimum extrusion speed. None of these nozzles, however, can print continuous straight lines at low speeds. Both nozzles can extrude thixotropic alloy on a substrate with a specified length at a rate of 5.08 mm/s, but the printing process was not stable. When the extrusion speed was increased to 6.35 mm/s, the instability issue still remained, and the 1 mm nozzle had a higher chance of producing discontinuous lines. Stable measurements were taken at an extrusion speed of approximately 7.62 mm/s. A nozzle with a diameter of 1.5 mm can print a continuous line with an average width of 1.83 mm at this extrusion speed. A 1.0 mm nozzle can produce lines with a width of 1.34 mm at the same speed. Increased extrusion speed resulted in more material being squeezed out of the nozzle tip, which increased the measured line width as well. The final speed recorded in this test was 13.21 mm/s, and both nozzles produced lines with a width of more than 5.5 mm. In particular, with the 1.5 mm diameter nozzle trial, the material flooded out of the outlet at an alarming rate, making it impossible to continue printing lines. Under the same printing conditions, both 1 mm and 1.5 mm nozzles require enough backpressure and shear rate inside the reservoir to change the thixotropic properties. Therefore, increasing the extrusion speed can instantly raise the shear rate, decreasing the material viscosity. However, when extrusion speed exceeds the stable printing zone, the thixotropic proprieties are no longer the primary factor to control the material flow rate.

### Effect of Distance Between Nozzle Tip and X-Y Platform

Next, we investigated the effect of the distance between the nozzle tip and the substrate on the printing resolution. Two nozzles with diameters of 1 mm and 1.5 mm were used for comparison purposes. The values of other main process parameters are listed in Table 4. To begin, a 1 mm thick gage block was used to determine the distance between the nozzle outlet and platform. The setup distance was initially set to 1 mm and then increased in 1 mm increments. During this test, the maximum distance was 30 mm.

TABLE 4

Printing parameters setup for the test

| | |
|---|---|
| Printing Parameters | Values |
| PID Set value [°C] | 83° C. |
| Nozzle diameter [mm] | 1.5 mm and 1 mm |
| Extrusion speed [mm/s] | 7.87 mm/s |
| X-Y platform moving speed [mm/s] | 4 mm/s |

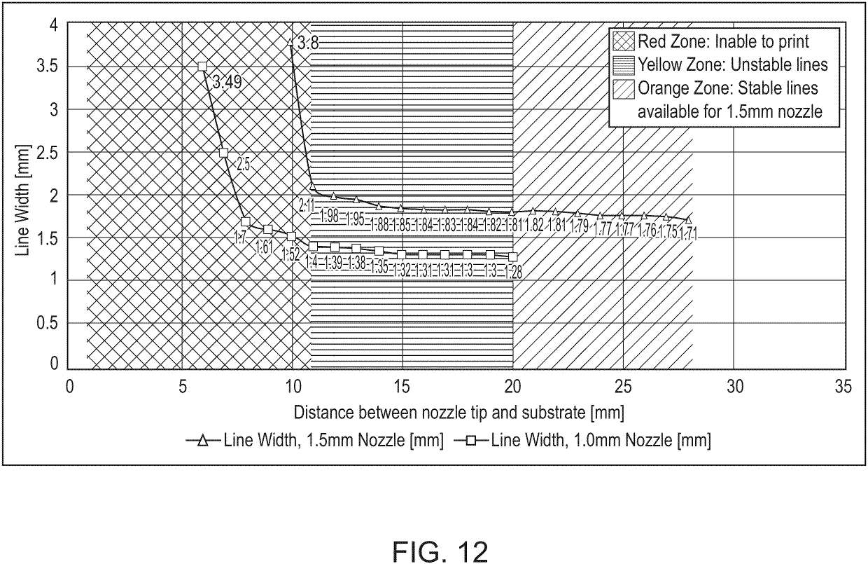

The line widths from different settings were measured and analyzed. FIG. 12 shows the distribution of line widths as the distance between the nozzle tip and the platform increased from 1 mm to 30 mm. It is demonstrated that when the gap distance is between 12 and 20 mm, both the two nozzles can produce fine metal lines. If the nozzle is positioned too close to the substrate, material extruded around the nozzle outlet will form a large droplet, which will eventually obstruct the nozzle tip. When the nozzle tip moves out of the blocked area, additional material is dragged out of the droplet, lowering the printing resolution. It was found that a setup distance between 12 and 22 mm produces the best printing results. Line widths for 1.5 mm and 1.0 mm nozzles varied slightly as distance increased. The 1.5 mm nozzle was capable of printing lines up to a distance of 28 mm on the substrate. The 1 mm nozzle, on the other hand, can reach a closer distance, but the material does not adhere to the substrate at the 21 mm distance trail.

### Effects of X-Y Platform Moving Speed

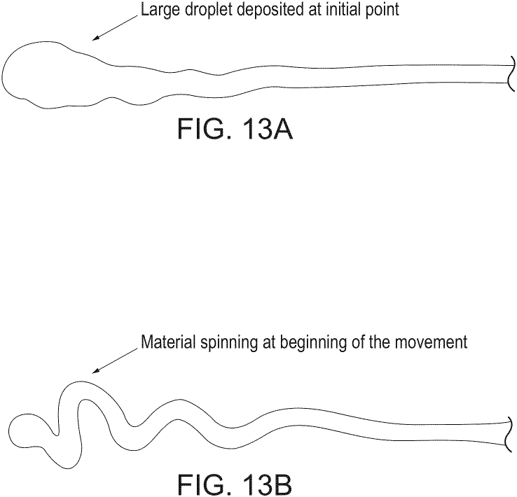

While the electric linear actuator can produce accurate control of the extrusion speed and can improve printing resolution, the actuator’s maximum and minimum movement capabilities limit printing effects. When the extrusion speed is set within a specified range, another significant parameter that can be adjusted is the X-Y platform movement speed. Two motorized linear actuators provide X and Y-axis movement for the printing system. The moving stage’s parameters can be configured via CNC control software. Acceleration along both axes was the first parameter considered in this study. Based on the motor movement profile, the CNC control software selected an acceleration value of approximately 50 mm/s². As illustrated in FIG. 13A, when the acceleration was lower than 50 mm/s², a significant amount of material was deposited at the initial point, increasing the risk of the nozzle tip becoming blocked. In contrast, when the acceleration was greater than 50 mm/s², the extruded thread spun, necessitating an extended preparation area to eliminate the spinning lines, as shown in FIG. 13B.

The second part of the test was to determine the effect of printing parameters at the same acceleration of on-axis moving speed. As specified in Table 4, the reservoir was heated to 83° C. and maintained at that temperature throughout the tests. The distance between nozzle tip and substrate was set to 15 mm, two nozzles with diameters of 1.5 mm 1.0 mm were compared, and the extrusion speed was set to 7.62 mm/s for the two nozzles.

TABLE 4

Printing parameters setup for the test

| | |
|---|---|
| Printing Parameters | Values |
| PID Set Value [°C] | 83° C. |
| Nozzle Diameter [mm] | 1.5 mm and 1 mm |
| Extrusion Speed [mm/s] | 7.62 mm/s |
| Distance between nozzle tip and substrate [mm] | 15 mm |

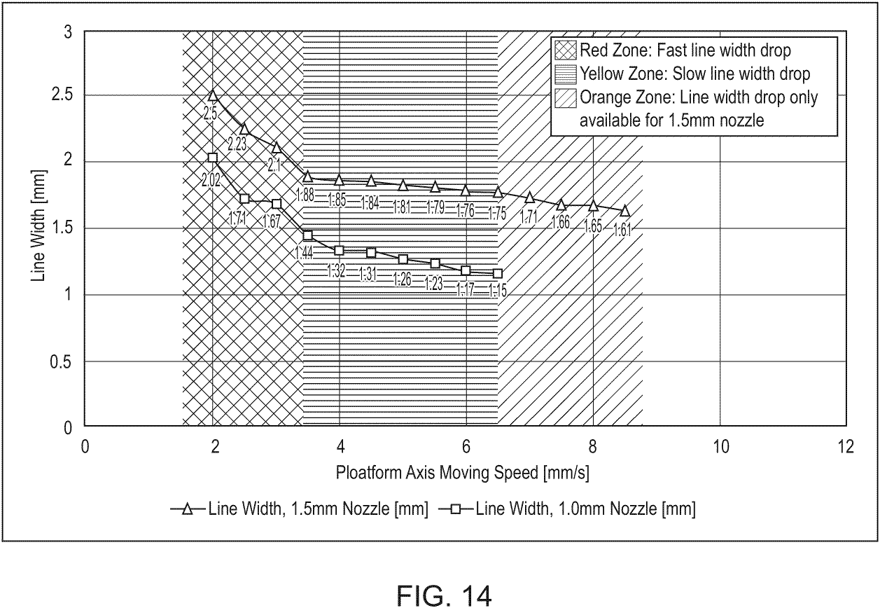

The printed line width with the 1.5 mm nozzle reaches an average of 2.5 mm at the slowest moving speed and then decreases dramatically as the moving speed increases to 3.5 mm/s, as shown in FIG. 14. When the moving speed is increased from 4 to 8 mm/s, the average line width measured on the substrate decreases gradually until the moving speed exceeds 8.5 mm/s. The results obtained with the 1 mm nozzle are consistent with those obtained with the 1.5 mm nozzle trails. The smaller-diameter nozzle, however, showed a limited adjustable moving speed range; discontinuous lines were detected and impacted the print quality at speeds greater than 6.5 mm/s. The best printing resolution for the 1.5 mm nozzle was 1.61 mm, which is 7.33% larger than the initial outlet diameter. Meanwhile, the 1.0 mm nozzle can print a line with a width of 1.15 mm, which is 15% wider than the 1.0 mm outlet.

### Printing Results With Optimized Process Parameters

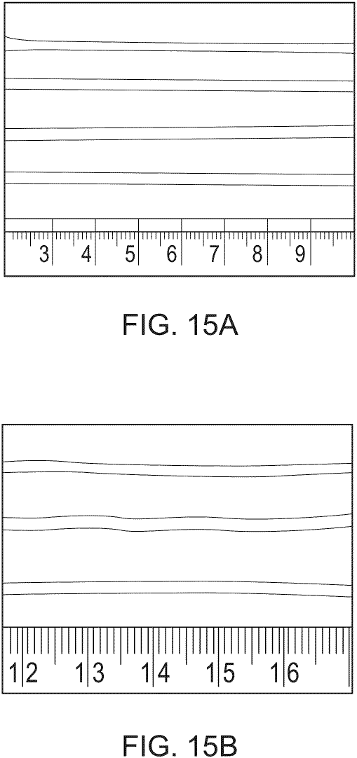

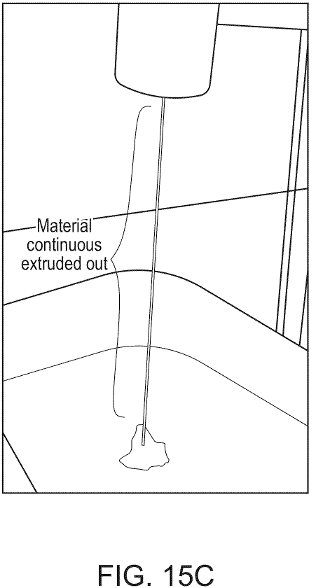

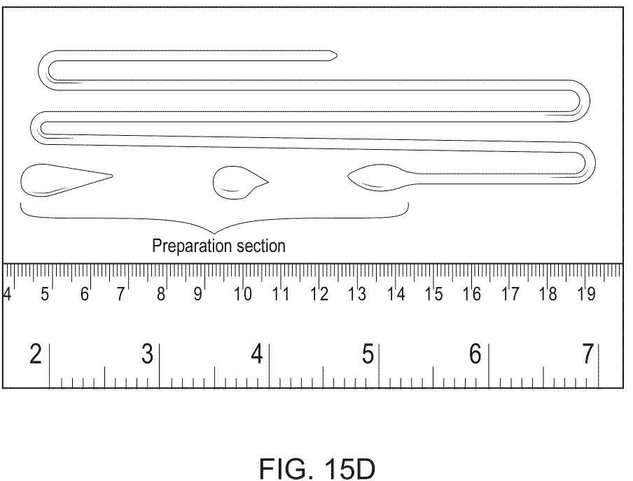

The printability study not only provided us with knowledge on the effects of major process parameters, but also enabled us to optimize the process and create good printing results. For the Bi-Pb alloy, we have accordingly conducted extensive calibration and configuration to develop an optimized printing procedure. The final printing trial with the Bi-Pb alloy was conducted with the following process settings: PID set value to 83° C., actuator extrusion speed to 7.62-7.87 mm/s, distance between the nozzle tip and the substrate to 15 mm, nozzle outlet diameters to 1.0 and 1.5 mm, X-Y motion speed to 4 mm/s, and X-Y platform acceleration to 50 mm/s². As illustrated in FIG. 15C, the thixotropic bismuth alloy was heated to 70.5° C. and then extruded through a single-piece nozzle. In FIGS. 15A and 15B, printed sample lines with nozzles of various diameters are shown. The printing system was examined to demonstrate the entire printing process using a 1.5 mm nozzle. As illustrated in FIG. 15D, the printing process included a material preparation step in which heated material was tuned to deposit as a stable line. The nozzle was able to print the desired geometry using CNC software after material preparation.

### Conclusion

From this research it has been demonstrated that metals and alloys may be thixotropically processed and printed by a properly designed extrusion-based 3D printing system, and the thixotropic properties can improve the metal printability. Direct thixotropic metal printing can help optimize the metal printing procedure to reduce post-printing treatments. Thixotropy as a time-dependent property for semi-solid metal processing has been investigated, and the major process parameter on printability has been examined. Low-melting-point alloys were chosen as materials for process demonstration and feasibility study.

An integrated SSM extruder and system was designed and utilized to produce uniform and qualified semi-solid alloy. The SSM extruder was designed to endure the harsh environment in alloy processing convoluted with thermomechanical competing effects. Meanwhile, modulated studies were conducted to understand the functional considerations of individual building blocks in the SSM extruder, for example, a properly designed heating mechanism. The SSM extruder may be used for direct printing or, alternatively, to create thixotropic alloy filaments that may be reheated for printing. In addition, computation simulations were conducted to better understand the dynamics of the process. Simulation results showed that the viscosity and velocity change during processing could significantly affect the dynamics of extrusion. The simulation also assisted in the determination of a temperature profile to create the desired liquid fraction for thixotropic processing.

Parametric studies were also conducted to understand the effects of the major process parameters on the printability during extrusion deposition. Bismuth-based alloy was selected as the testing material for printability study. In particular, the effects of nozzle diameter, extrusion speed, nozzle-to-substrate distance, and platform moving speed and acceleration on the printability were examined. Accordingly, the extrusion and printing system was optimized to achieve desired printing results. The final printing test demonstrated that the integrated system is capable of effectively processing raw alloys in the thixotropic sate and then directly printing by extrusion deposition.

Alternatively, instead of depositing the alloy in a slurried thixotropic state, a thixotropically formed alloy can be provided in a solid filament state. This method utilizes the metal alloy’s thixotropic property (shear-thinning behavior) to accomplish additive manufacturing.

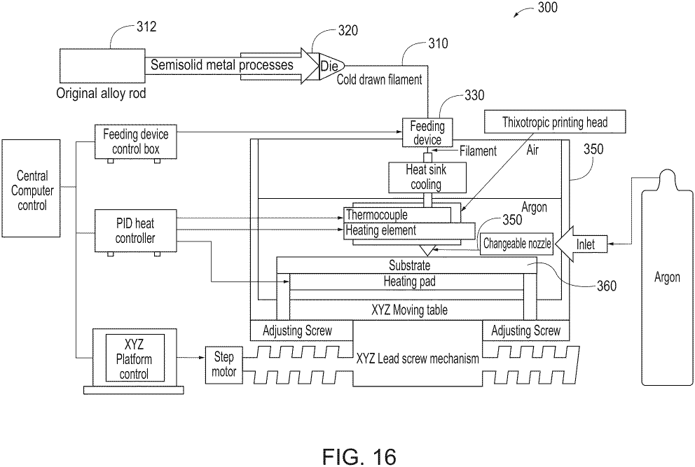

Referring to FIG. 16, a printing system 300 is shown. A solid filament 310 can be used as a feeding stock to start printing by drawing a feed stock 312 in the form of an alloy rod through a die 320, provided to hopper 130 and fed to auger bit 120, where the alloy is converted into a thixotropic state via shear action of the auger bit 120 and the heating of heating elements 150, 152, 162, so that the alloy is discharged from the nozzle 160 in a thixotropic state.

A feeding device 330 transports the metal alloy filament 310 into a heating zone 340 and an exchangeable nozzle 350 with an desired speed. The heating zone 340 provides proper and controllable heating and make the filament 310 into a desired temperature zone, such as a semi-solid state. The printing process has to be in argon protected environment 350, since the oxidation of the printed material leads to printing failure. An adjustable heated substrate 360 offers a leveled printing surface with heat, which helps to balance the heating dynamics between the nozzle 350 and substrate 360. An XYZ moving table 370 contributes to 3D object manufacturing.

A thesis entitled “Thixotropic Mixing and 3D Printing of Biodegradable Alloys for Medical Implant Applications” is attached hereto as an Appendix to this application and is incorporated herein as though fully set forth.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method of thixotropic mixing and 3D printing of alloys comprising the steps of:
(a) locating a thixotropic mixer having a discharge nozzle above a substrate;
(b) adding a molten alloy to the mixer;
(c) locating the nozzle between about 1 mm and about 20 mm from the substrate; and
(d) extruding the alloy through the nozzle onto the substrate.

2. The method according to claim 1, wherein the nozzle has a discharge diameter between about 0.1 mm and about 3 mm.

3. The method according to claim 1, wherein the alloy comprises an In-Ga alloy.

4. The method according to claim 3, wherein the In-Ga alloy is a 70/30 In-Ga alloy.

5. The method according to claim 1, wherein the alloy comprises a Bi-Pb alloy.

6. The method according to claim 5, wherein the Bi-Pb alloy is a 56/44 Bi-Pb alloy.

7. The method according to claim 1, wherein step (d) comprises extruding the alloy in a thixotropic state.

8. The method according to claim 1, wherein step (d) is performed in the absence of total solidification of the alloy.

9. The method according to claim 1, wherein step (d) comprises heating the nozzle.

10. The method according to claim 1, wherein step (a), comprises providing the thixotropic mixer comprising:
(i) a drive train;
(ii) an auger bit operatively connected to the drive train;
(iii) a hopper for receiving alloy material and depositing the material to the auger bit;
(iv) a material transfer channel housing the auger bit and configured to receive the material from the hopper;
(v) a first heating element in the material transfer channel and configured to heat the material to a first temperature;
(vi) a second heating element in the material transfer channel and configured to heat the material to a second temperature, different from the first temperature; and
(vii) a nozzle located downstream of the auger and configured to discharge the alloy from the mixer.

11. The method according to claim 10, wherein the first temperature is higher than the second temperature.

12. The method according to claim 10, further comprising a nozzle heater at the nozzle.

13. A method of printing a thixotropic alloy comprising the steps of:
(a) forming a two-phase slurry, containing a plurality of β-phase grains dispersed in a molten α-phase; and
(b) feeding the slurry into an extruder for 3D printing.

14. The method according to claim 13, wherein the slurry comprises a first element and second element, different from the first element.

15. The method according to claim 14, wherein step (a) comprises the steps of:
(a)(1) melting the first element;
(a)(2) adding the second element to the first element;
(a)(3) mixing the first and second elements together to form an alloy; and
(a)(4) cooling the alloy to about 50° C. while under vigorous mixing.

16. The method according to claim 13, further comprising the step of:
(c) heating the slurry in the extruder at a first temperature; and
(d) after step (c), heating the slurry in the extruder at a second temperature, lower than the first temperature.

17. The method according to claim 16, further comprising, after step (d), the step of:
(e) extruding the slurry through a nozzle.

18. The method according to claim 17, wherein step (e) comprises heating the slurry at the nozzle.

19. A method of 3D printing an alloy comprising the steps of:
(a) forming a thixotropic alloy;
(b) drawing the alloy into a filament; and
(c) feeding the filament into an extruder for 3D printing.

20. The method according to claim 19, further comprising the step of:
(d) heating the filament to a semi-solid state in the extruder.
